(19) United States
(12) Patent Application Publication
(10) Pub. No.: US 2024/0427866 A1
(43) Pub. Date: Dec. 26, 2024

(54) AUTHENTICATION APPARATUS, MOBILE TERMINAL, AND AUTHENTICATION METHOD

(71) Applicant: NEC Corporation, Minato-ku, Tokyo (JP)

(72) Inventor: Yasuji Saito, Tokyo (JP)

(73) Assignee: NEC CORPORATION, Minato-ku, Tokyo (JP)

(21) Appl. No.: 18/703,523

(22) PCT Filed: Nov. 12, 2021
(86) PCT No.: PCT/JP2021/041789

§ 371 Date: Apr. 22, 2024

(51) Int. Cl. G06F 21/32; G06F 21/33

(52) U.S. Cl. CPC G06F 21/32; G06F 21/33

(57) ABSTRACT

An authentication apparatus (10) includes an acquisition unit (110) and an authentication unit (120). The acquisition unit (110) acquires, from a mobile terminal (20), master biological information of a target person and biological information for authentication, the biological information for authentication being biological information of the target person generated by the mobile terminal (20). The authentication unit (120) performs authentication processing of the target person by using the biological information for authentication and the master biological information. The authentication apparatus (10) may further include an entry processing unit (130). The entry processing unit (130) performs at least a part of processing for allowing the target person to enter a target area, when the authentication unit (120) generates authenticated information indicating that authentication of the target person is successful.

### TECHNICAL FIELD

The present invention relates to an authentication apparatus, a mobile terminal, an authentication method, an information processing method, and a program.

### BACKGROUND ART

In recent years, biological authentication has been used in various scenes. For example, Patent Document 1 describes controlling an entrance gate by using face image data. Specifically, a mobile terminal of a user transmits a face image of the user to an authentication server via a facility terminal. The authentication server collates the face image received from the mobile terminal with a face image registered in a membership information database, and performs authentication of the user. Then, the authentication server transmits an authentication result to the facility terminal. The facility terminal is provided with a visual confirmation button. When the facility terminal indicates that the authentication result is authenticated, and the visual confirmation button is pressed by a receptionist, the facility terminal transmits entrance permission information to an entrance gate apparatus that controls the entrance gate.

### RELATED DOCUMENT

### Patent Document

Patent Document 1: Japanese Patent Application Publication No. 2006-146796

### SUMMARY OF INVENTION

### Technical Problem

In a method described in Patent Document 1, it is necessary to register a biological image serving as a master in an authentication server. One example of an object of the present invention is to enable to perform biological authentication without registering in advance a biological image serving as a master in an authentication server.

### Solution to Problem

One aspect of the present invention provides an authentication apparatus including:
an acquisition unit that acquires, from a mobile terminal, master biological information of a target person, and biological information for authentication being biological information of the target person generated by the mobile terminal; and
an authentication unit that performs authentication processing of the target person by using the biological information for authentication and the master biological information.

One aspect of the present invention provides an authentication apparatus including:
an acquisition unit that acquires, from a mobile terminal, authenticated information indicating that biological information for authentication being biological information of a target person generated by the mobile terminal is authenticated by using master biological information of the target person; and
an entry processing unit that performs at least a part of processing for allowing the target person to enter a target area when the authenticated information is acquired.

One aspect of the present invention provides a mobile terminal including:
a storage unit that stores master biological information of a target person;
a biological information acquisition unit that acquires biological information for authentication being biological information of the target person; and
a transmission unit that transmits the master biological information and the biological information for authentication to an authentication apparatus that performs authentication processing of the biological information for authentication.

One aspect of the present invention provides a mobile terminal including:
a storage unit that stores master biological information of a target person;
a biological information acquisition unit that acquires biological information for authentication being biological information of the target person;
an authentication unit that performs authentication processing of the target person by using the biological information for authentication and the master biological information; and
a transmission unit that transmits an authentication result of the authentication unit to an entry processing apparatus that performs at least a part of processing for allowing the target person to enter a target area, when at least authentication of the target person is successful.

One aspect of the present invention provides an authentication method including,
by a computer executing:
   acquisition processing of acquiring, from a mobile terminal, master biological information of a target person, and biological information for authentication being biological information of the target person generated by the mobile terminal; and
   authentication processing of performing authentication processing of the target person by using the biological information for authentication and the master biological information.

One aspect of the present invention provides an authentication method including,
by a computer executing:
   acquisition processing of acquiring, from a mobile terminal, authenticated information indicating that biological information for authentication being biological information of a target person generated by the mobile terminal is authenticated by using master biological information of the target person; and
   entry processing of performing at least a part of processing for allowing the target person to enter a target area when the authenticated information is acquired.

One aspect of the present invention provides an information processing method including,
by a mobile terminal:
   storing master biological information of a target person;
   executing biological information acquisition processing of acquiring biological information for authentication being biological information of the target person; and
   executing transmission processing of transmitting the master biological information and the biological information for authentication to an authentication apparatus that performs authentication processing of the biological information for authentication.

One aspect of the present invention provides an authentication method including,
by a mobile terminal:
   storing master biological information of a target person;
   executing biological information acquisition processing of acquiring biological information for authentication being biological information of the target person;
   executing authentication processing of performing authentication processing of the target person by using the biological information for authentication and the master biological information; and
   executing transmission processing of transmitting an authentication result of the authentication processing to an entry processing apparatus that performs at least a part of processing for allowing the target person to enter a target area, when at least authentication of the target person is successful.

One aspect of the present invention provides a program causing a computer to include:
an acquisition function of acquiring, from a mobile terminal, master biological information of a target person, and biological information for authentication being biological information of the target person generated by the mobile terminal; and
an authentication function of performing authentication processing of the target person by using the biological information for authentication and the master biological information.

One aspect of the present invention provides a program causing a computer to perform and include:
an acquisition function of acquiring, from a mobile terminal, authenticated information indicating that biological information for authentication being biological information of a target person generated by the mobile terminal is authenticated by using master biological information of the target person; and
an entry processing function of performing at least a part of processing for allowing the target person to enter a target area when the authenticated information is acquired.

One aspect of the present invention provides a program causing a mobile terminal storing master biological information of a target person to include:
a biological information acquisition function of acquiring biological information for authentication being biological information of the target person; and
a transmission function of transmitting the master biological information and the biological information for authentication to an authentication apparatus that performs authentication processing of the biological information for authentication.

One aspect of the present invention provides a program causing a mobile terminal storing master biological information of a target person to include:
a biological information acquisition function of acquiring biological information for authentication being biological information of the target person;
an authentication function of performing authentication processing of the target person by using the biological information for authentication and the master biological information; and
a transmission function of transmitting an authentication result of the authentication function to an entry processing apparatus that performs at least a part of processing for allowing the target person to enter a target area, when at least authentication of the target person is successful.

### Advantageous Effects of Invention

According to one aspect of the present invention, biological authentication can be performed without registering in advance a biological image serving as a master in an authentication server.

### BRIEF DESCRIPTION OF THE DRAWINGS

The above-described object, the other objects, features, and advantages will become more apparent from suitable example embodiments described below and the following accompanying drawings.

FIG. 1 It is a diagram illustrating a usage environment of an authentication apparatus according to a first example embodiment.

FIG. 2 It is a diagram illustrating one example of a functional configuration of the authentication apparatus.

FIG. 3 It is a diagram illustrating one example of information stored by a storage unit.

FIG. 4 It is a diagram illustrating one example of a functional configuration of a mobile terminal.

FIG. 5 It is a diagram illustrating a hardware configuration example of the authentication apparatus.

FIG. 6 It is a flowchart illustrating one example of processing to be performed by the authentication apparatus together with processing to be performed by the mobile terminal.

FIG. 7 It is a flowchart illustrating processing to be performed when a target person enters a predetermined floor or room of the building, after the processing illustrated in FIG. 6 is performed.

FIG. 8 It is a diagram for describing information stored by a storage unit in a second example embodiment.

FIG. 9 It is a diagram illustrating one example of processing to be performed by an authentication apparatus according to the second example embodiment.

FIG. 10 It is processing to be performed when a target person enters a predetermined floor or room of the building, after the processing illustrated in FIG. 9 is performed.

FIG. 11 It is a diagram illustrating one example of processing to be performed by an authentication apparatus according to a third example embodiment.

FIG. 12 It is a diagram illustrating one example of processing to be performed by an authentication apparatus according to a fourth example embodiment.

FIG. 13 It is a diagram illustrating one example of a functional configuration of an authentication apparatus according to a fifth example embodiment.

FIG. 14 It is a diagram illustrating one example of a functional configuration of a mobile terminal according to the fifth example embodiment.

### EXAMPLE EMBODIMENT

Hereinafter, example embodiments according to the present invention are described by using the drawings. Note that, in all drawings, a similar constituent element is indicated by a similar reference sign, and description thereof is not included, as necessary.

### First Example Embodiment

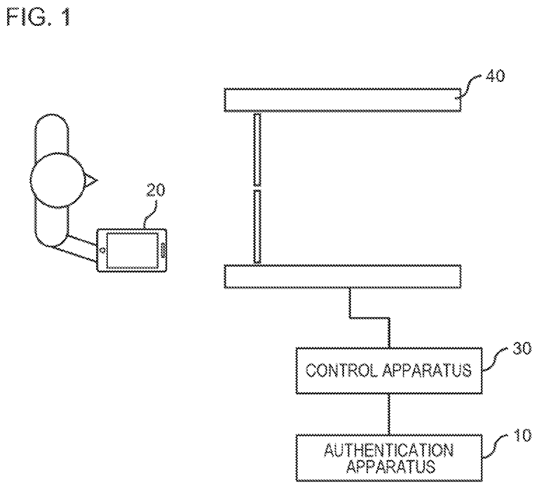

FIG. 1 is a diagram illustrating a usage environment of an authentication apparatus 10 according to a present example embodiment. The authentication apparatus 10 authenticates a target person by using biological information. One example of biological information is face information, but the biological information may be biological information other than the above, for example, fingerprint information, vein information, or iris information. Further, biological information may be information in which a plurality of pieces of the above-described information are combined.

The authentication apparatus 10 is used together with a mobile terminal 20. The mobile terminal 20 is in the possession of a user. The mobile terminal 20 includes a function as an electronic identification card, for example, an electronic employee identification card, and stores in advance master biological information of a target person. Further, the mobile terminal 20 generates biological information for authentication being biological information of a target person, and transmits the generated biological information for authentication to the authentication information 10 together with master biological information. The authentication apparatus 10 performs authentication processing of a target person by using the biological information for authentication and master biological information acquired from the mobile terminal 20.

The mobile terminal 20 may store at least one of target person identification information given to the target person, and terminal identification information given to the mobile terminal 20. In this case, the mobile terminal 20 transmits at least one of target person identification information and terminal identification information together with the biological information for authentication and master biological information, as necessary. One example of target person identification information is, for example, a target person ID such as an employee ID.

In the example illustrated in FIG. 1, the authentication apparatus 10 is further used together with a control apparatus 30. The control apparatus 30 performs at least a part of processing for allowing a target person to enter a target area. For example, the control apparatus 30 opens a gate 40 installed at an entrance of a target area. As another example, the control apparatus 30 releases a lock of a door installed at an entrance of a target area. A target area may be a place where a plurality of facilities gather, for example, a theme park, may be a building itself, may be a predetermined floor within a building, or may be a part of a predetermined floor within a building, for example, a predetermined room. Further, when the control apparatus 30 opens the gate 40, or release a lock of a door, the control apparatus 30 may perform processing of informing a target person of the above by turning on a light emitting apparatus installed at the gate 40 or the door, or the like.

The authentication apparatus 10 may communicate with the mobile terminal 20 via a public line such as the Internet, or may communicate with the mobile terminal 20 via a wireless communication apparatus provided near the gate 40 or a door. In the latter case, the authentication apparatus 10 acquires at least one of biological information for authentication and master biological information, and target person identification information and terminal identification information via the wireless communication apparatus. A communicable distance between the wireless communication apparatus and the mobile terminal 20 is, for example, equal to or less than 5 m, preferably equal to or less than 3 m, and more preferably equal to or less than 1.5 m, but is not limited thereto.

Note that, a plurality of gates 40 may be disposed in parallel at an entrance of a target area. In this case, the authentication apparatus 10 and a wireless communication apparatus may be provided for each of the plurality of gates 40. Herein, it is preferable to provide a shielding member that suppresses passing of a radio wave, for example, a shielding plate between the adjacent gates 40. This reduces a possibility that the terminal 20 carried by a target person who is trying to pass through a certain gate 40 may erroneously communicate with a wireless communication apparatus provided at a gate 40 adjacent to the certain gate 40.

Further, a plurality of mobile terminals 20 may be simultaneously present within a communication area of a wireless communication apparatus, and these plurality of mobile terminals 20 may become communicable with a wireless communication apparatus. In this case, an acquisition unit 110 acquires reception intensity at a time when a radio being output from the mobile terminal 20 is received by the wireless communication apparatus, and determines the mobile terminal 20 to be processed by using the reception intensity. For example, the acquisition unit 110 determines the mobile terminal 20 to be processed in a descending order of reception intensity.

Securing that authentication processing by the authentication apparatus 10 is successful may be a part of a condition for opening a gate or releasing a lock of a door. As one example, there is a case in which a person who is allowed to enter in advance a target area may be determined in advance. After authentication processing by the authentication apparatus 10 is successful, and further when it can be confirmed that a target person is a person who is allowed to enter the target area, the control apparatus 30 may open the gate or release a lock of the door. The confirmation is performed, for example, by using at least one of target person identification information and terminal identification information.

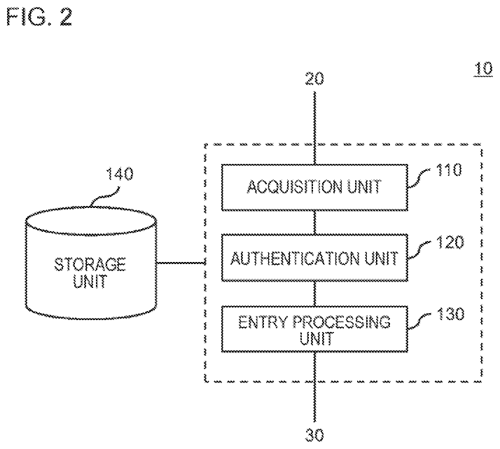

FIG. 2 is a diagram illustrating one example of a functional configuration of the authentication apparatus 10. The authentication apparatus 10 includes the acquisition unit 110, an authentication unit 120, and an entry processing unit 130.

The acquisition unit 110 acquires master biological information and biological information for authentication from the mobile terminal 20. Further, the acquisition unit 110 also acquires another piece of information from the mobile terminal 20, as necessary. One example of another piece of information is at least one of target person identification information and terminal identification information.

The authentication unit 120 performs authentication processing of a target person by using biological information for authentication and master biological information acquired by the acquisition unit 110. For example, the authentication unit 120 computes a matching degree of biological information for authentication with respect to master biological information, and determines that authentication of a target person is successful when the matching degree becomes equal to or more than a reference value. When authentication is successful, the authentication unit 120 generates authenticated information indicating the above.

When the authentication unit 120 generates authenticated information, the entry processing unit 130 performs at least a part of processing for allowing a target person to enter a target area. The part of the processing is optionally set depending on functions distributed for the entry processing unit 130 and the control apparatus 30. One example of the part of the processing is transmitting authenticated information to the control apparatus 30.

The authentication apparatus 10 further includes a storage unit 140. The storage unit 140 stores, for each target area, at least one of target person identification information of a person who is allowed to enter the target area and terminal identification information. Further, the storage unit 140 also stores another piece of information, as necessary. Note that, the storage unit 140 may be located outside the authentication apparatus 10.

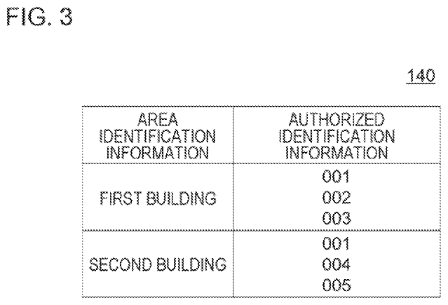

FIG. 3 is a diagram illustrating one example of information stored in the storage unit 140. In the example illustrated in FIG. 3, the storage unit 140 stores area identification information that identifies a target area, and authorized identification information in association with each other. Authorized identification information is at least one of target person identification information of a target person who is allowed to enter the target area, and terminal identification information of the mobile terminal 20 used by the target person. In FIG. 3, area identification information is indicated building by building, but the storage unit 140 may store authorized identification information also room by room, or floor by floor.

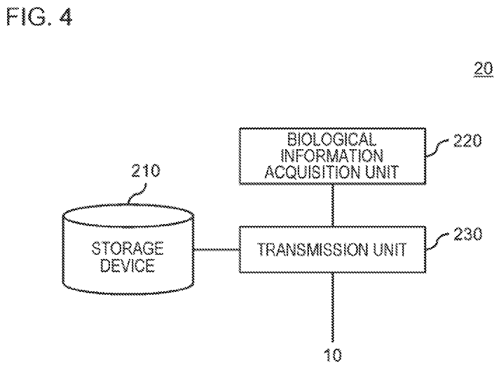

FIG. 4 is a diagram illustrating one example of a functional configuration of the mobile terminal 20. The mobile terminal 20 includes a storage unit 210, a biological information acquisition unit 220, and a transmission unit 230.

The storage unit 210 stores master biological information of a target person using the mobile terminal 20. The storage unit 210 further stores at least one of target person identification information of a target person using the mobile terminal 20, and terminal identification information of the mobile terminal 20 used by the target person. Hereinafter, the identification information is described as authentication identification information.

The biological information acquisition unit 220 acquires biological information for authentication being biological information of a target person. As one example, the biological information acquisition unit 220 includes a sensor that acquires biological information, and acquires biological information for authentication by using the sensor. One example of a sensor included in the biological information acquisition unit 220 is an image capturing sensor. Note that, biological information may be an image generated by a sensor, for example, a face image, or may be a feature value generated by processing the image, for example, a feature value of a face.

The transmission unit 230 transmits, to the authentication apparatus 10, master biological information stored in the storage unit 210, and biological information for authentication generated by the biological information acquisition unit 220.

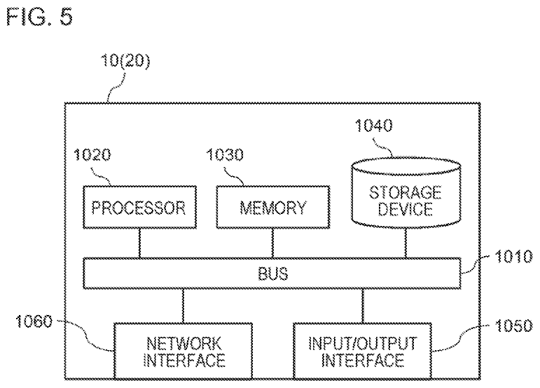

FIG. 5 is a diagram illustrating a hardware configuration example of the authentication apparatus 10. The authentication apparatus 10 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a removable medium such as a memory card, a read only memory (ROM), or the like. The storage device 1040 stores a program module that achieves each function (e.g., the acquisition unit 110, the authentication unit 120, and the entry processing unit 130) of the authentication apparatus 10. Each function associated with a program module is achieved by causing the processor 1020 to read each program module in the memory 1030 and execute the program module. Further, the storage device 1040 also functions as the storage unit 140.

The input/output interface 1050 is an interface for connecting the authentication apparatus 10 to various pieces of input/output equipment. For example, the input/output interface 1050 includes a near-field wireless communication module. In this case, the authentication apparatus 10 communicates with the mobile terminal 20 via the input/output interface 1050.

The network interface 1060 is an interface for connecting the authentication apparatus to a network. The network is, for example, a local area network (LAN) or a wide area network (WAN). A method of connecting the network interface 1060 to the network may be wireless connection, or may be wired connection. The authentication apparatus 10 may communicate with the mobile terminal 20 via the network interface 1060.

Note that, a hardware configuration of the mobile terminal 20 is also similar to the hardware configuration of the authentication apparatus 10 illustrated in FIG. 5. Herein, preferably, a device that stores at least master biological information among the storage device 1040 serving as the storage unit 210 is configured in such a way that stored information cannot be tampered with.

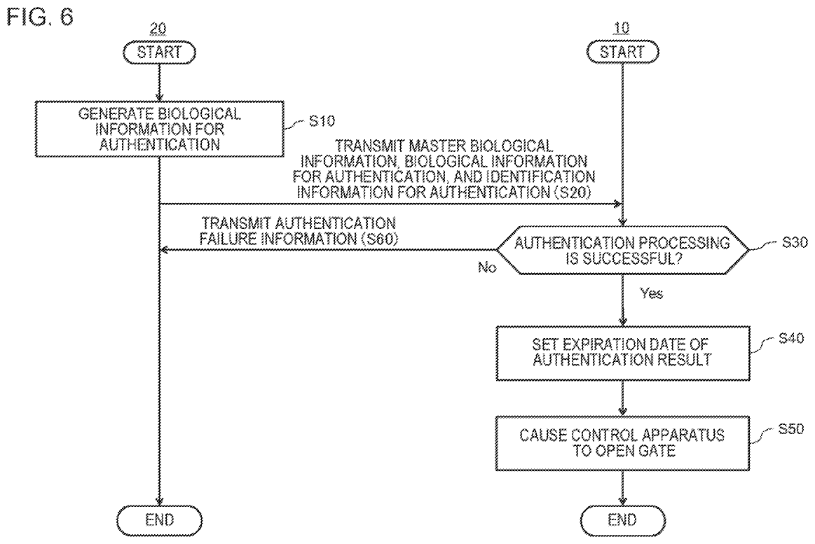

FIG. 6 is a flowchart illustrating one example of processing to be performed by the authentication apparatus 10 together with processing to be performed by the mobile terminal 20. The processing illustrated in FIG. 6 is performed when a target person passes through the gate 40 installed at an entrance of a building.

In the example illustrated in FIG. 6, the control apparatus 30 controls each of the gate 40 installed at an entrance of a building, and a lock of a door provided in a room within the building. Then, when a target person passes through the gate 40, at least authentication by biological information is required. Herein, authentication by authentication identification information, specifically, at least one of target person identification information and terminal identification information may be further required.

First, when a target person approaches the gate 40, the biological information acquisition unit 220 of the mobile terminal 20 generates biological information for authentication of the target person (step S10). The processing may be performed by triggered by allowing a target person to perform predetermined input to the mobile terminal 20, or by allowing the mobile terminal 20 to perform near-field wireless communication with a communication apparatus provided near the gate 40. Then, the mobile terminal 20 is caused to transmit the biological information for authentication to the authentication apparatus 10 together with master biological information and authentication identification information (step S20). Note that, as described above, authentication identification information is at least one of target person identification information and terminal identification information.

The acquisition unit 110 of the authentication apparatus 10 acquires biological information for authentication and master biological information transmitted from the mobile terminal 20. Then, the authentication unit 120 of the authentication apparatus 10 performs authentication processing of the biological information for authentication by using the master biological information. When the authentication is successful (step S30: Yes), the authentication unit 120 generates the above-described authenticated information, specifically, information indicating that authentication is successful. Note that, when the authentication has failed (step S30: No), the authentication unit 120 transmits information indicating the above to the mobile terminal 20 (step S60).

When authenticated information is generated, the entry processing unit 130 sets an expiration date of the authenticated information, and causes the storage unit 140 to store the expiration date in association with the authentication identification information (step S40). The expiration date of authenticated information is, for example, a predetermined time after generation of the authenticated information. The predetermined time is, for example, settable by an administrator of a building. As one example, the predetermined time is twenty-four hours, but may be a value other than the above, for example, twelve hours or eight hours.

Subsequently, the entry processing unit 130 causes the control apparatus 30 to open the gate 40 (step S50). This allows the target person to pass through the gate 40, and enter the building.

Herein, the acquisition unit 110 may acquire area identification information given to a building to which a target person tries to enter this time. In this case, the entry processing unit 130 may read, from the storage unit 140, authorized identification information associated with area identification information acquired by the acquisition unit 110, and include, in a condition for performing step S50, that the authorized identification information includes authentication identification information acquired by the acquisition unit 110.

Note that, there are various methods of acquiring area identification information by the acquisition unit 110. As a first example, when the mobile terminal 20 communicates with the authentication apparatus 10 via a wireless apparatus installed near the gate 40, the wireless apparatus stores area identification information, and transmits the area identification information to the authentication apparatus 10 together with information acquired from the mobile terminal 20. As a second example, a target person operates the mobile terminal 20, and causes the mobile terminal 20 to transmit area identification information to the authentication apparatus 10.

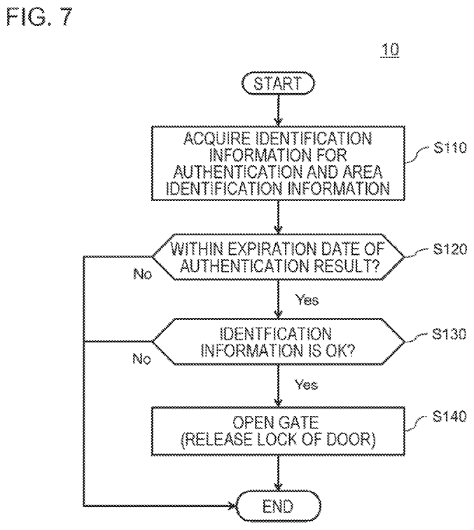

FIG. 7 is processing to be performed when a target person enters a predetermined floor or room of the building, after the processing illustrated in FIG. 6 is performed. In the processing, the authentication apparatus 10 does not perform authentication by biological information, and performs authentication by authentication identification information in place of the above.

A door or a gate is installed at an entrance of a predetermined floor of a building. Further, a door is installed at an entrance of a room of the building. Then, the control apparatus 30 controls opening/closing of the gate, or a lock of the door. Further, a wireless communication apparatus for communicating with the mobile terminal 20 is provided near the gate or the door. The authentication apparatus 10 communicates with the mobile terminal 20 via the wireless communication apparatus.

When a target person approaches the gate or the door, authentication identification information is transmitted from the mobile terminal 20 to the authentication apparatus 10 via the wireless communication apparatus. The acquisition unit 110 of the authentication apparatus 10 acquires the authentication identification information. At this occasion, the acquisition unit 110 also acquires area identification information. An acquisition method of the area identification information is as described with reference to FIG. 6 (step S110).

The authentication unit 120 of the authentication apparatus 10 confirms whether an expiration date associated with authentication identification information acquired in step S110 is stored in the storage unit 140. When the expiration date is stored, and the expiration date is not expired (step S120: Yes), the authentication unit 120 reads, from the storage unit 140, authorized identification information associated with the area identification information acquired in step S110. Then, the authentication unit 120 confirms whether the read authorized identification information includes the authentication identification information acquired in step S110 (step S130). When the authorized identification information includes the authentication identification information (step S130: Yes), the entry processing unit 130 causes the control apparatus 30 to open the gate, or release a lock of the door (step S140).

Note that, in step S40 in FIG. 6, the entry processing unit 130 may set an expiration date of authorized information by using schedule information of a target person. For example, schedule information includes information indicating a target area to which the target person should go, and a date and time when the target person is scheduled to stay in the target area. As one example, schedule information stores a place where a meeting is held, and a date and time when the meeting is held. Then, the entry processing unit 130 sets an expiration date in such a way that the date and time when the target person is scheduled to stay are included for each target area, and causes the storage unit 140 to store the expiration date for each target person and in association with area identification information. In this case, in step S120 in FIG. 7, the authentication unit 120 acquires and uses an expiration date associated with the area identification information acquired in step S110.

Further, when a target person enters a predetermined floor or room of the building, the processing illustrated in FIG. 6 may be performed, in place of the processing illustrated in FIG. 7. However, in this case, processing illustrated in step S40 may not be performed in each of cases where a target person enters a building, and a target person enters a predetermined floor or room of the building.

In the foregoing, according to the present example embodiment, the mobile terminal 20 stores master biological information. Then, when biological information for authentication is generated, the mobile terminal 20 transmits the biological information for authentication to the authentication apparatus 10 together with master biological information. Then, the authentication apparatus 10 performs authentication processing by using the biological information for authentication and the master biological information acquired from the mobile terminal 20. Therefore, it is possible to cause the authentication apparatus 10 to perform authentication processing without registering master biological information in the authentication apparatus 10.

### Second Example Embodiment

The present example embodiment is similar to the first example embodiment except for the following point. First, a mobile terminal 20 transmits, to an authentication apparatus 10, information indicating a position of the mobile terminal 20 at a time when biological information for authentication is acquired, in addition to information described in the first example embodiment. Hereinafter, the information is described as position information for authentication. Then, the authentication apparatus 10 performs at least a part of processing for allowing a target person to enter a target area, when a positional relationship between a position indicated by position information for authentication, and the target area satisfies a first criterion.

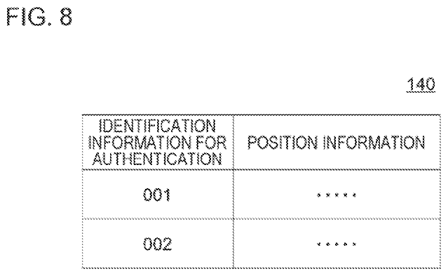

FIG. 8 is a diagram illustrating information stored in a storage unit 140 in the present example embodiment. The storage unit 140 stores authentication identification information and position information for authentication acquired from the mobile terminal 20 in association with each other, in addition to the information described in the first example embodiment. An entry processing unit 130 of the authentication apparatus 10 uses information illustrated in FIG. 8.

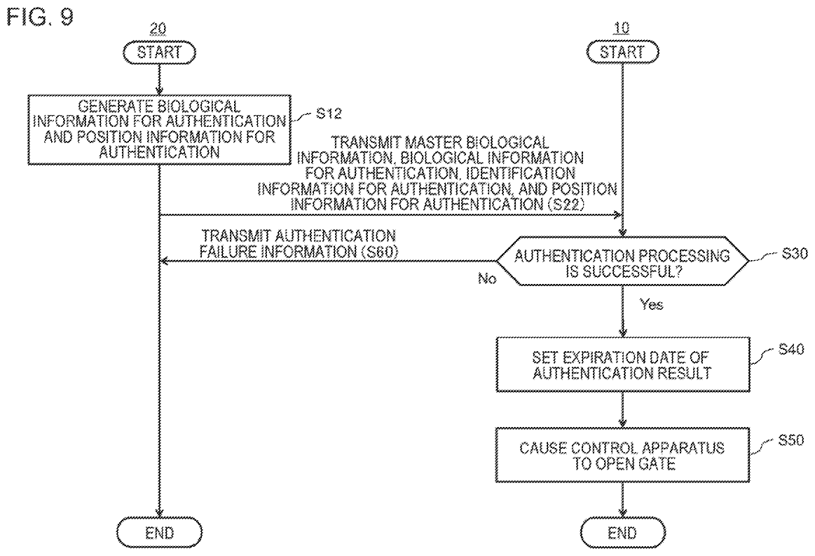

FIG. 9 is a diagram illustrating one example of processing to be performed by the authentication apparatus 10 according to the present example embodiment, and is associated with FIG. 6 in the first example embodiment. The processing illustrated in FIG. 9 is also performed when a target person passes through a gate 40 installed at an entrance of a building.

When a target person approaches the gate 40, a biological information acquisition unit 220 of the mobile terminal 20 generates biological information for authentication of the target person. At this occasion, the mobile terminal 20 also generates position information for authentication. The position information for authentication is generated by using, for example, a GPS (step S12). Then, the mobile terminal 20 transmits the biological information for authentication and the position information for authentication to the authentication apparatus 10 together with master biological information and authentication identification information (step S22).

Pieces of processing thereafter (steps S30 to S60) are as described with reference to FIG. 6. However, when authentication of the target person is successful, in step S40, an authentication unit 120 further causes the storage unit 140 to store authentication identification information and position information for authentication in association with each other.

Note that, in step S22 in FIG. 9, an acquisition unit 110 of the authentication apparatus 10 acquires biological information for authentication and master biological information transmitted from the mobile terminal 20. In view of the above, in step S30 in FIG. 9, the authentication unit 120 of the authentication apparatus 10 may perform authentication processing of biological information for authentication by using master biological information and position information for authentication. Specifically, when authentication of biological information is successful, and when position information for authentication and a position of the gate lie within a predetermined range (step S30: Yes), the authentication unit 120 generates the above-described authenticated information, specifically, information indicating that authentication is successful. Note that, when the authentication has failed (step S30: No), the authentication unit 120 transmits information indicating the above to the mobile terminal 20 (step S60).

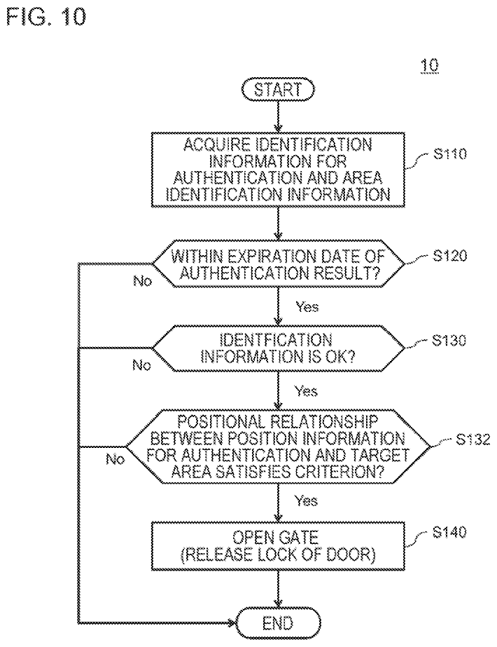

FIG. 10 is associated with FIG. 7 in the first example embodiment, and is processing to be performed when a target person enters a predetermined floor or room of the building, after the processing illustrated in FIG. 9 is performed.

Pieces of processing illustrated in steps S110 to S130 are as described with reference to FIG. 7. When authorized identification information read from the storage unit 140 includes authentication identification information (step S130: Yes), the entry processing unit 130 further reads, from the storage unit 140, position information for authentication associated with authentication identification information, and determines whether a positional relationship between the position information for authentication and a target area satisfies the first criterion (step S132). The first criterion is set, for example, in such a way that a time required for moving on foot from a position indicated by position information for authentication to a target area becomes equal to or less than a reference value. The reference value is, for example, ten minutes, but is not limited thereto. Then, when the criterion is satisfied (step S132: Yes), the entry processing unit 130 causes a control apparatus 30 to open the gate, or release a lock of the door (step S140).

Also according to the present example embodiment, it is possible to cause the authentication apparatus 10 to perform authentication processing without registering master biological information in the authentication apparatus 10. Further, when the control apparatus 30 is caused to open a gate, or release a lock of a door, the entry processing unit 130 determines whether a positional relationship between a position of the mobile terminal 20 at a time when biological information for authentication is generated, and a target area satisfies the first criterion. This prevents the control apparatus 30 from opening a gate, or releasing a lock of a door, when a position of the mobile terminal 20 at a time when biological information for authentication is generated is away from a target area, and a target person is not supposed to be present in the target area at timing at which the target person is authenticated. Therefore, a possibility that another person may inadvertently enter a target area is lowered.

Further, when a target person enters a predetermined floor or room of the building, the processing illustrated in FIG. 9 may be performed, in place of the processing illustrated in FIG. 10. However, in this case, processing illustrated in step S40 may not be performed in each of cases where a target person enters a building, and a target person enters a predetermined floor or room of the building.

### Third Example Embodiment

The present example embodiment is similar to the first example embodiment or the second example embodiment except for the following point. First, a mobile terminal 20 transmits, to an authentication apparatus 10, information indicating a date and time when the mobile terminal 20 acquires biological information for authentication, in addition to information described in the first example embodiment or the second example embodiment. Hereinafter, the information is described as date and time information for authentication. Then, an authentication unit 120 of the authentication apparatus 10 performs authentication processing, when a time difference between timing at which authentication processing is performed, and a date and time indicated by date and time information for authentication satisfies a second criterion. The second criterion is, for example, that a time difference is equal to or less than one minute.

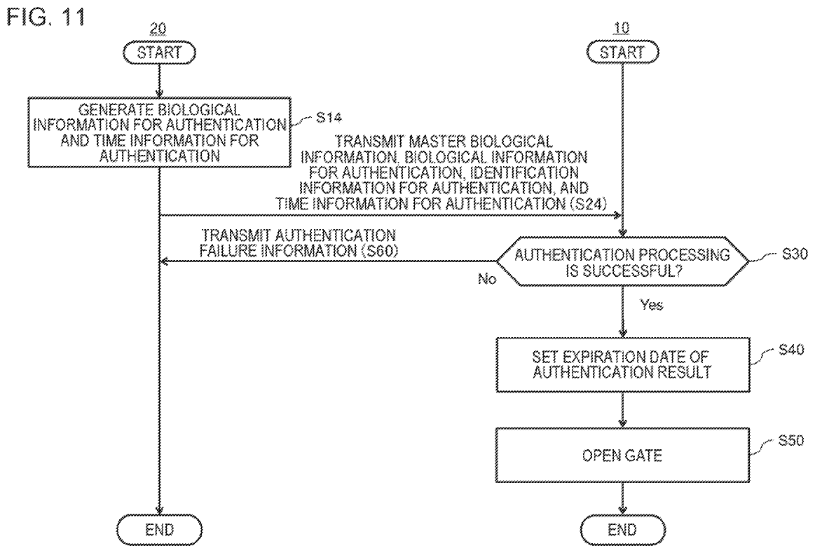

FIG. 11 is a diagram illustrating one example of processing to be performed by the authentication apparatus 10 according to the present example embodiment, and is associated with FIG. 6 in the first example embodiment. The processing illustrated in FIG. 11 is also performed when a target person passes through a gate 40 installed at an entrance of a building.

When a target person approaches the gate 40, a biological information acquisition unit 220 of the mobile terminal 20 generates biological information for authentication of the target person. At this occasion, the mobile terminal 20 also generates date and time information for authentication (step S14). Then, the mobile terminal 20 is caused to transmit the biological information for authentication and the date and time information for authentication to the authentication apparatus 10 together with master biological information and authentication identification information (step S24).

Pieces of processing thereafter (steps S30 to S60) are as described with reference to FIG. 6. However, in step S30, the authentication unit 120 performs authentication processing, when a time difference between timing at which authentication processing is performed, and a date and time indicated by date and time information for authentication satisfies the second criterion. In other words, when the time difference does not satisfy the second criterion, the authentication unit 120 determines that authentication of the target person has failed.

Also according to the present example embodiment, it is possible to cause the authentication apparatus 10 to perform authentication processing without registering master biological information in the authentication apparatus 10. Further, when a time difference between timing at which authentication processing is performed, and a date and time when biological information for authentication is generated does not satisfy the second criterion, the authentication unit 120 does not perform authentication processing. Therefore, even when there is another person who has acquired biological information of a target person generated in past, and master biological information of the target person, a possibility that the another person may enter a target area is lowered.

### Fourth Example Embodiment

The present example embodiment is similar to any of the above-described example embodiments except for the following point. First, a storage unit 210 of a mobile terminal 20 stores certificate information. The certificate information certifies that the mobile terminal 20 is a terminal to be utilized together with an authentication apparatus 10. Then, the authentication apparatus 10 sets acquiring the certificate information from the authentication apparatus 10, as a condition for performing authentication processing, or a condition for securing that authentication processing is successful.

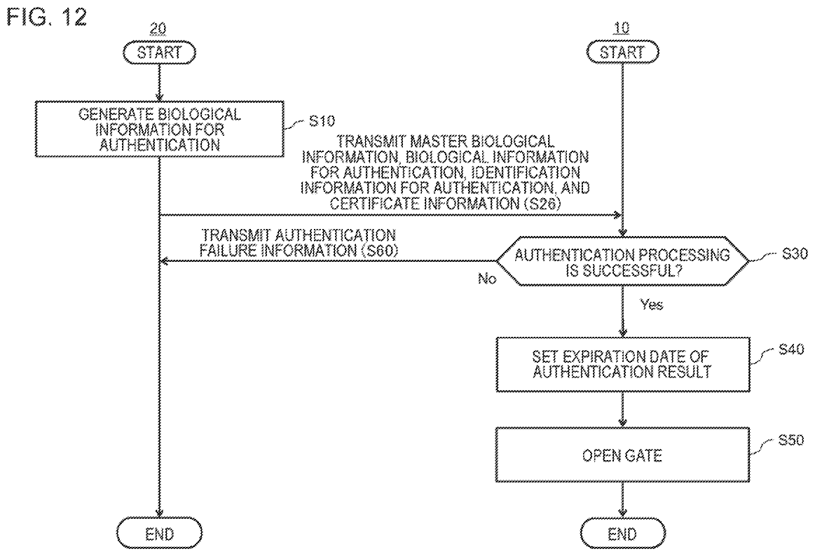

FIG. 12 is a diagram illustrating one example of processing to be performed by the authentication apparatus 10 according to the present example embodiment, and is associated with FIG. 6 in the first example embodiment. The processing illustrated in FIG. 12 is also performed when a target person passes through a gate 40 installed at an entrance of a building.

When a target person approaches the gate 40, a biological information acquisition unit 220 of the mobile terminal 20 generates biological information for authentication of the target person (step S10). Then, the mobile terminal 20 is caused to transmit the biological information for authentication to the authentication apparatus 10 together with master biological information and certificate information (step S26).

Pieces of processing thereafter (steps S30 to S60) are as described with reference to FIG. 6. However, in step S30, an authentication unit 120 performs authentication processing, when an acquisition unit 110 acquires certificate information from the mobile terminal 20. In other words, when certificate information is not acquired, the authentication unit 120 determines that authentication of the target person has failed.

Also according to the present example embodiment, it is possible to cause the authentication apparatus 10 to perform authentication processing without registering master biological information in the authentication apparatus 10. Further, when certificate information is not acquired from the mobile terminal 20, the authentication unit 120 does not perform authentication processing. Therefore, a possibility that a person who does not carry a regular mobile terminal 20 may inadvertently enter a target area is lowered.

### Fifth Example Embodiment

The present example embodiment is similar to any of the above-described example embodiments except for a point that a mobile terminal 20 performs authentication processing.

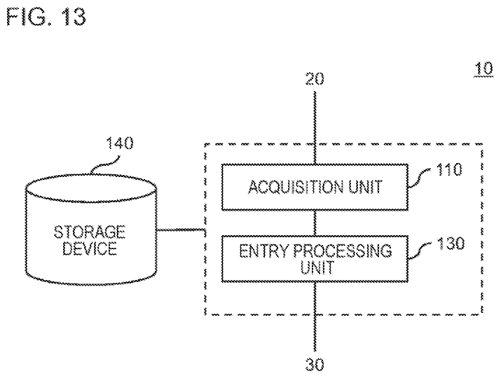

FIG. 13 is a diagram illustrating one example of a functional configuration of an authentication apparatus 10 according to the present example embodiment. The authentication processing 10 illustrated in FIG. 13 is similar to any of the authentication apparatuses 10 according to the above-described example embodiments except for the following point.

First, the authentication apparatus 10 does not include an authentication unit 120. In place of this, an acquisition unit 110 acquires, from the mobile terminal 20, authenticated information, specifically, information indicating that authentication of a target person is successful. Then, an entry processing unit 130 performs processing described in the above-described example embodiments by using the authenticated information.

For example, in a case similar to that of the first example embodiment, the mobile terminal 20 transmits authenticated information to the authentication apparatus 10. Then, the authentication apparatus 10 performs processing described in the first example embodiment by using the authenticated information.

For example, in a case similar to that of the second example embodiment, the mobile terminal 20 transmits position information for authentication to the authentication apparatus 10 together with authenticated information. Then, the authentication apparatus 10 performs processing described in the second example embodiment by using the position information for authentication.

Further, in a case similar to that of the third example embodiment, the mobile terminal 20 transmits date and time information for authentication to the authentication apparatus 10 together with authenticated information. Then, the authentication apparatus 10 performs processing described in the third example embodiment by using the date and time information for authentication.

For example, in a case similar to that of the fourth example embodiment, the mobile terminal 20 transmits certificate information to the authentication apparatus 10 together with authenticated information. Then, the entry processing unit 130 of the authentication apparatus 10 performs processing described in the above-described example embodiments, when the acquisition unit 110 acquires authenticated information and certificate information.

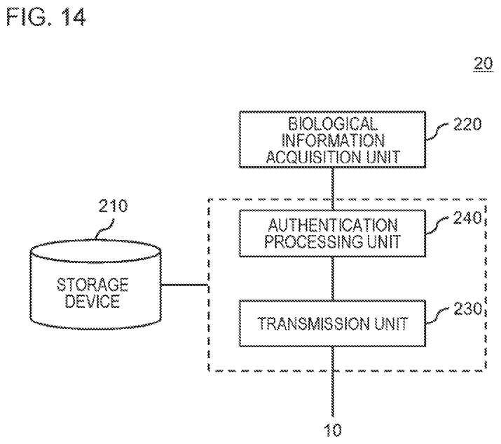

FIG. 14 is a diagram illustrating one example of a functional configuration of the mobile terminal 20 according to the present example embodiment. The mobile terminal 20 illustrated in FIG. 14 is similar to any of the mobile terminals 20 according to the above-described example embodiments except for a point that the mobile terminal 20 includes an authentication processing unit 240.

The authentication processing unit 240 performs authentication processing of a target person by using biological information for authentication acquired by a biological information acquisition unit 220, and master biological information stored in a storage unit 210. Processing to be performed herein is similar to processing to be performed by the authentication unit 120 of the authentication apparatus 10 in the above-described example embodiments.

Then, when authentication by the authentication processing unit 240 is successful, a transmission unit 230 transmits, to the authentication apparatus 10, authenticated information generated by the authentication processing unit 240. At this occasion, the transmission unit 230 transmits, to the authentication apparatus 10, at least one of position information for authentication, date and time information for authentication, and certificate information, as necessary.

According to the present example embodiment, the authentication apparatus 10 can acquire an authentication result of a target person, even when master biological information is not stored.

As described above, while the example embodiments according to the present invention have been described with reference to the drawings, these example embodiments are an example of the present invention, and various configurations other than the above can also be adopted.

Further, in a plurality of flowcharts used in the above description, a plurality of processes (pieces of processing) are described in order. However, an order of execution of processes to be performed in each example embodiment is not limited to the order of description. In each example embodiment, the illustrated order of processes can be changed within a range that does not adversely affect a content. Further, the above-described example embodiments can be combined, as far as contents do not conflict with each other.

A part or all of the above-described example embodiments may also be described as the following supplementary notes, but is not limited to the following.

1. An authentication apparatus including:
an acquisition unit that acquires, from a mobile terminal, master biological information of a target person, and biological information for authentication being biological information of the target person generated by the mobile terminal; and
an authentication unit that performs authentication processing of the target person by using the biological information for authentication and the master biological information.

2. The authentication apparatus according to supplementary note 1, wherein
the acquisition unit acquires, from the mobile terminal, certificate information for certifying the mobile terminal, and
the authentication unit sets acquiring the certificate information, as a condition for performing the authentication processing, or a condition for securing that the authentication processing is successful.

3. The authentication apparatus according to supplementary note 1 or 2, further including
an entry processing unit that performs at least a part of processing for allowing the target person to enter a target area when the authentication unit generates authenticated information indicating that authentication of the target person is successful.

4. An authentication apparatus including:
an acquisition unit that acquires, from a mobile terminal, authenticated information indicating that biological information for authentication being biological information of a target person generated by the mobile terminal is authenticated by using master biological information of the target person; and
an entry processing unit that performs at least a part of processing for allowing the target person to enter a target area when the authenticated information is acquired.

5. The authentication apparatus according to supplementary note 4, wherein
the acquisition unit acquires, from the mobile terminal, certificate information for certifying the mobile terminal, and
the entry processing unit sets acquiring the certificate information, as a condition for performing at least the part of the processing.

6. The authentication apparatus according to any one of supplementary notes 3 to 5, wherein
the target area is associated in advance with authorized identification information that identifies at least one of an authorized person being the target person who has authority to enter the target area, and an authorized terminal being the mobile terminal carried by the authorized person,
the acquisition unit acquires, from the mobile terminal, authentication identification information that identifies at least one of the target person and the mobile terminal, and
the entry processing unit
   sets an expiration date of the authenticated information, and
   performs at least the part of the processing, when the authentication identification information is acquired within the expiration date, and the authentication identification information is included in the authorized identification information.

7. The authentication apparatus according to supplementary note 6, wherein
the acquisition unit acquires schedule information indicating a schedule of the target person, and
the entry processing unit sets the expiration date for the each target area by using the schedule information.

8. The authentication apparatus according to any one of supplementary notes 3 to 7, wherein
the acquisition unit acquires position information for authentication indicating a position of the mobile terminal at a time when the mobile terminal acquires the biological information for authentication, and
the entry processing unit performs at least the part of the processing, when a positional relationship between a position indicated by the position information for authentication, and the target area satisfies a first criterion.

9. The authentication apparatus according to any one of supplementary notes 1 to 3, wherein
the acquisition unit acquires date and time information for authentication indicating a date and time when the mobile terminal acquires the biological information for authentication, and
the authentication unit performs the authentication processing when a time difference from a date and time indicated by the date and time information for authentication satisfies a second criterion.

10. A mobile terminal including:
a storage unit that stores master biological information of a target person;
a biological information acquisition unit that acquires biological information for authentication being biological information of the target person; and
a transmission unit that transmits the master biological information and the biological information for authentication to an authentication apparatus that performs authentication processing of the biological information for authentication.

11. A mobile terminal including:
a storage unit that stores master biological information of a target person;
a biological information acquisition unit that acquires biological information for authentication being biological information of the target person;
an authentication unit that performs authentication processing of the target person by using the biological information for authentication and the master biological information; and
a transmission unit that transmits an authentication result of the authentication unit to an entry processing apparatus that performs at least a part of processing for allowing the target person to enter a target area, when at least authentication of the target person is successful.

12. An authentication method including,
by a computer executing:
   acquisition processing of acquiring, from a mobile terminal, master biological information of a target person, and biological information for authentication being biological information of the target person generated by the mobile terminal; and
   authentication processing of performing authentication processing of the target person by using the biological information for authentication and the master biological information.

13. The authentication method according to supplementary note 12, further including,
by the computer:
   in the acquisition processing, acquiring, from the mobile terminal, certificate information for certifying the mobile terminal; and
   in the authentication processing, setting acquiring the certificate information, as a condition for performing the authentication processing, or a condition for securing that the authentication processing is successful.

14. The authentication method according to supplementary note 12 or 13, further including,
by the computer,
executing entry processing of performing at least a part of processing for allowing the target person to enter a target area, when authenticated information indicating that authentication of the target person is successful is generated in the authentication processing.

15. An authentication method including,
by a computer executing:
   acquisition processing of acquiring, from a mobile terminal, authenticated information indicating that biological information for authentication being biological information of a target person generated by the mobile terminal is authenticated by using master biological information of the target person; and
   entry processing of performing at least a part of processing for allowing the target person to enter a target area when the authenticated information is acquired.

16. The authentication method according to supplementary note 15, further including,
by the computer:
   in the acquisition processing, acquiring, from the mobile terminal, certificate information for certifying the mobile terminal; and
   in the entry processing, setting acquiring the certificate information, as a condition for performing at least the part of the processing.

17. The authentication method according to any one of supplementary notes 14 to 16, wherein
the target area is associated in advance with authorized identification information that identifies at least one of an authorized person being the target person who has authority to enter the target area, and an authorized terminal being the mobile terminal carried by the authorized person,
the method further including,
by the computer:
   in the acquisition processing, acquiring, from the mobile terminal, authentication identification information that identifies at least one of the target person and the mobile terminal; and
   in the entry processing,
      setting an expiration date of the authenticated information; and
      performing at least the part of the processing, when the authentication identification information is acquired within the expiration date, and the authentication identification information is included in the authorized identification information.

18. The authentication method according to supplementary note 17, further including,
by the computer:
   in the acquisition processing, acquiring schedule information indicating a schedule of the target person; and
   in the entry processing, setting the expiration date for the each target area by using the schedule information.

19. The authentication method according to any one of supplementary notes 14 to 18, further including,
by the computer:
   in the acquisition processing, acquiring position information for authentication indicating a position of the mobile terminal at a time when the mobile terminal acquires the biological information for authentication; and
   in the entry processing, performing at least the part of the processing, when a positional relationship between a position indicated by the position information for authentication, and the target area satisfies a first criterion.

20. The authentication method according to any one of supplementary notes 12 to 14, further including,
by the computer:
   in the acquisition processing, acquiring date and time information for authentication indicating a date and time when the mobile terminal acquires the biological information for authentication; and
   in the authentication processing, performing the authentication processing, when a time difference from a date and time indicated by the date and time information for authentication satisfies a second criterion.

21. An information processing method including,
by a mobile terminal:
   storing master biological information of a target person;
   executing biological information acquisition processing of acquiring biological information for authentication being biological information of the target person; and
   executing transmission processing of transmitting the master biological information and the biological information for authentication to an authentication apparatus that performs authentication processing of the biological information for authentication.

22. An authentication method including,
by a mobile terminal:
   storing master biological information of a target person;
   executing biological information acquisition processing of acquiring biological information for authentication being biological information of the target person;
   executing authentication processing of performing authentication processing of the target person by using the biological information for authentication and the master biological information; and
   executing transmission processing of transmitting an authentication result of the authentication processing to an entry processing apparatus that performs at least a part of processing for allowing the target person to enter a target area, when at least authentication of the target person is successful.

23. A program causing a computer to include:
an acquisition function of acquiring, from a mobile terminal, master biological information of a target person, and biological information for authentication being biological information of the target person generated by the mobile terminal; and
an authentication function of performing authentication processing of the target person by using the biological information for authentication and the master biological information.

24. The program according to supplementary note 23, wherein
the acquisition function acquires, from the mobile terminal, certificate information for certifying the mobile terminal, and
the authentication function sets acquiring the certificate information, as a condition for performing the authentication processing, or a condition for securing that the authentication processing is successful.

25. The program according to supplementary note 23 or 24, further including
an entry processing function that performs at least a part of processing for allowing the target person to enter a target area, when the authentication function generates authenticated information indicating that authentication of the target person is successful.

26. A program causing a computer to perform and include:
an acquisition function that acquires, from a mobile terminal, authenticated information indicating that biological information for authentication being biological information of a target person generated by the mobile terminal is authenticated by using master biological information of the target person; and
an entry processing function that performs at least a part of processing for allowing the target person to enter a target area when the authenticated information is acquired.

27. The program according to supplementary note 26, wherein
the acquisition function acquires, from the mobile terminal, certificate information for certifying the mobile terminal, and
the entry processing function sets acquiring the certificate information, as a condition for performing at least the part of the processing.

28. The program according to any one of supplementary notes 25 to 27, wherein
the target area is associated in advance with authorized identification information that identifies at least one of an authorized person being the target person who has authority to enter the target area, and an authorized terminal being the mobile terminal carried by the authorized person,
the acquisition function acquires, from the mobile terminal, authentication identification information that identifies at least one of the target person and the mobile terminal, and
the entry processing function
   sets an expiration date of the authenticated information, and
   performs at least the part of the processing, when the authentication identification information is acquired within the expiration date, and the authentication identification information is included in the authorized identification information.

29. The program according to supplementary note 28, wherein
the acquisition function acquires schedule information indicating a schedule of the target person, and
the entry processing function sets the expiration date for the each target area by using the schedule information.

30. The program according to any one of supplementary notes 25 to 29, wherein
the acquisition function acquires position information for authentication indicating a position of the mobile terminal at a time when the mobile terminal acquires the biological information for authentication, and
the entry processing function performs at least the part of the processing, when a positional relationship between a position indicated by the position information for authentication, and the target area satisfies a first criterion.

31. The program according to any one of supplementary notes 23 to 25, wherein
the acquisition function acquires date and time information for authentication indicating a date and time when the mobile terminal acquires the biological information for authentication, and
the authentication function performs the authentication processing when a time difference from a date and time indicated by the date and time information for authentication satisfies a second criterion.

32. A program causing a mobile terminal storing master biological information of a target person to include:
a biological information acquisition function of acquiring biological information for authentication being biological information of the target person; and
a transmission function of transmitting the master biological information and the biological information for authentication to an authentication apparatus that performs authentication processing of the biological information for authentication.

33. A program causing a mobile terminal storing master biological information of a target person to include:
a biological information acquisition function of acquiring biological information for authentication being biological information of the target person;
an authentication function of performing authentication processing of the target person by using the biological information for authentication and the master biological information; and
a transmission function of transmitting an authentication result of the authentication function to an entry processing apparatus that performs at least a part of processing for allowing the target person to enter a target area, when at least authentication of the target person is successful.

### REFERENCE SIGNS LIST

10 Authentication apparatus
20 Mobile terminal
30 Control apparatus
40 Gate
110 Acquisition unit
120 Authentication unit
130 Entry processing unit
140 Storage unit
210 Storage unit
220 Biological information acquisition unit
230 Transmission unit
240 Authentication processing unit

What is claimed is:

1. An authentication apparatus comprising:
at least one memory configured to store instructions; and
at least one processor configured to execute the instructions to:
acquire, from a mobile terminal, master biological information of a target person and biological information for authentication, the biological information for authentication being biological information of the target person generated by the mobile terminal; and
perform authentication processing of the target person by using the biological information for authentication and the master biological information.

2. The authentication apparatus according to claim 1, wherein
the at least one processor is further configured to execute the instructions to:
acquire, from the mobile terminal, certificate information for certifying the mobile terminal, and
set acquiring the certificate information, as a condition for performing the authentication processing, or a condition for securing that the authentication processing is successful.

3. The authentication apparatus according to claim 1, wherein the at least one processor is further configured to execute the instructions to
perform at least a part of processing for allowing the target person to enter a target area, when generating authenticated information indicating that authentication of the target person is successful.

4-5. (canceled)

6. The authentication apparatus according to claim 3, wherein
the target area is associated in advance with authorized identification information that identifies at least one of an authorized person being the target person who has authority to enter the target area, and an authorized terminal being the mobile terminal carried by the authorized person,
the at least one processor is further configured to execute the instructions to:
acquire, from the mobile terminal, authentication identification information that identifies at least one of the target person and the mobile terminal;
set an expiration date of the authenticated information; and
perform at least the part of the processing, when the authentication identification information is acquired within the expiration date, and the authentication identification information is included in the authorized identification information.

7. The authentication apparatus according to claim 6, wherein
the at least one processor is further configured to execute the instructions to:
acquire schedule information indicating a schedule of the target person; and
set the expiration date for the each target area by using the schedule information.

8. The authentication apparatus according to claim 3, wherein
the at least one processor is further configured to execute the instructions to:
acquire position information for authentication indicating a position of the mobile terminal at a time when the mobile terminal acquires the biological information for authentication; and
perform at least the part of the processing, when a positional relationship between a position indicated by the position information for authentication, and the target area satisfies a first criterion.

9. The authentication apparatus according to claim 1, wherein
the at least one processor is further configured to execute the instructions to:
acquire authentication date and time information indicating a date and time when the mobile terminal acquires the biological information for authentication; and
perform the authentication processing, when a time difference from a date and time indicated by the date and time information for authentication satisfies a second criterion.

10. A mobile terminal comprising:
at least one memory configured to store instructions; and
at least one processor configured to execute the instructions to:
store master biological information of a target person;
acquire biological information for authentication being biological information of the target person; and
transmit the master biological information and the biological information for authentication to an authentication apparatus that performs authentication processing of the biological information for authentication.

11. (canceled)

12. An authentication method executed by a computer, comprising:
acquiring, from a mobile terminal, master biological information of a target person, and biological information for authentication being biological information of the target person generated by the mobile terminal; and
performing authentication processing of the target person by using the biological information for authentication and the master biological information.

13-19. (canceled)
